(19) United States
(12) Patent Application Publication
(10) Pub. No.: US 2007/0007777 A1
(43) Pub. Date: Jan. 11, 2007

(54) Non-handed window lock actuator

(76) Inventor: She Shun Zhang, Shanghai (CN)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/175,103

(22) Filed: Jul. 6, 2005

(51) Int. Cl. E05B 3/00

(52) U.S. Cl. 292/336.3

(57) ABSTRACT

A non-handed actuator for window locks of the type in which a lock control member is moved by the actuator to control the locking of a window sash to a window frame. The actuator includes a housing base that is securable to the window frame and a handle is secured to the base for pivoting about a first axis and a drive link is secured for pivoting with the handle. A connecting link is securable at its distal end to the lock control member of a window lock. The connecting link is pivotally secured at its proximal end to the drive link. The connecting link is provided as a selectable pair which are generally a mirror image of each other, one provided and dimensioned for right-hand operation of the lock control member and the other provided for left-hand operation of a lock control. The unneeded connecting link is discarded. The connecting links are generally L-shaped so that the proximal end of the connecting link is received in a cavity provided in the base. A pivot pin pivotally connects the connecting link to the drive link and the cavity within the housing base is dimensioned for retaining and confining this connection without the need for additional mechanical securement.

### BACKGROUND OF THE INVENTION

The present invention relates generally to window locks, and more particularly to manually operated actuators for window locks.

Window locks are known in the art generally having a catch with a handle actuator affixed to a window frame which interacts with a keeper on a corresponding section of a moveable window sash to securely hold the sash tightly against the frame. Also known in the art are devices for sequential multi-point locking of the moveable window sash with the window frame. These latter devices are locks which have a handle actuator interacting with a keeper at one point on a window frame and sash respectively which causes a second lock to engage a keeper at a distant location.

Such locks are most often manually controlled by a pivoting handle operatively connected to a tie bar moveable along one side of the window frame, whereby pivoting of the handle moves the connected tie bar and the cam members thereon into or out of engagement with associated keepers on the window sash.

A problem encountered with non-handed window lock actuators of the prior art is that they tend to be expensive to manufacture due to the multiplicity of parts and further due to the mechanical requirements for connecting the parts together, particularly the link arms, which connections also tend to be unreliable over periods of use. The present invention is directed toward overcoming these problems and for providing additional features which make the overall actuator less expensive to manufacture.

### SUMMARY OF THE INVENTION

The non-handed (applicable to either left-handed or right-handed operation) actuator of the present invention is intended for use in window locks of the type in which a lock control member, such as a tie bar, is moved by the actuator to control the locking of the window sash to a window frame. Such a common type window lock may be observed in U.S. Pat. No. 4,991,886.

The actuator of the present invention includes a housing base which is securable to the window frame and a handle is secured to the base for pivoting about a first axis through a predetermined angle. The handle generally extends in a first radial direction from this axis.

A drive link is secured for pivoting with the handle and the drive link generally extends in a second radially direction from the first axis. A connecting link is securable at a distal end thereof to the lock control member or tie bar of a window lock with a hook connection in the form of a keyed flange depending from the distal end at generally a right angle. This connecting link is pivotally secured at a proximal end thereof to the drive link.

A first embodiment of the present invention resides in providing the connecting link as a selectable pair wherein one connecting link is dimensioned and shaped for right-hand operation of the lock control member as a right-hand lock and the other connecting link is dimensioned and shaped for left-hand operation of the lock control member as a left-hand lock. It has been found that it is less expensive to provide excessive connecting links wherein one is discarded depending upon whether the actuator is left-hand or right-hand operation than it is to provide an actuator which is non-handed through the use and incorporation of a single connecting link. This is because in the latter situation such an arrangement requires more moving parts and connections and is therefore ultimately more expensive to manufacture.

The right-hand and left-hand connecting links are generally L-shaped and the proximal end of the selected connecting link is received in a cavity provided in the housing base and a pivot pin pivotally connects the connecting link to the drive link. The cavity is dimensioned for retaining and confining this pivot pin, the proximal end of the connecting link and the drive link all together in confined pivotal connection without the requirement of other mechanical securements. Because if this arrangement, unreliable and expensive mechanical keepers or fasteners are eliminated, thereby providing a second feature of the present invention.

The pivot pin connecting the connecting link and the drive link in one embodiment may be provided whereby it is smaller in diameter at one end thereof thereby providing an annular shoulder for supporting the connecting link in spaced relationship from the drive link within the housing base cavity. Accordingly the pivot pin is slidably confined within the dimensions of the base cavity and the links are maintained in spaced relationship whereby they do not grind against each other. The other end of this pivot pin may be non-rotatably keyed in engagement with the drive link.

### BRIEF DESCRIPTION OF THE DRAWINGS

Other objects and advantages appear hereinafter in the following description and claims. The appended drawings show, for the purpose of exemplification, without limiting the scope of the invention or appended claims, certain practical embodiments of the present invention wherein:

FIG. 1 is an exploded perspective view of the non-handed actuator of the present invention for a window lock; and

FIG. 2 is a view in back vertical elevation of the housing base portion of the actuator assembly shown in FIG. 1 exposing the interior cavity of the base.

### DETAILED DESCRIPTION OF A PREFERRED EMBODIMENT

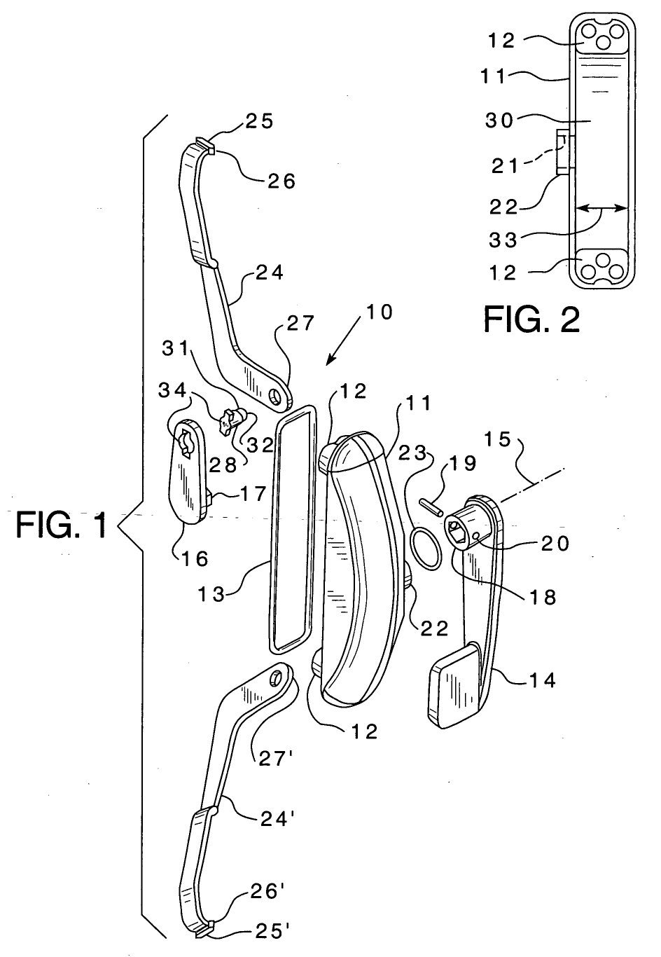

Referring to FIGS. 1 and 2, the non-handed actuator 10 of the present invention is shown. The actuator 10 consists of a housing base 11 which is securable to a window frame (not shown) by screws secured in bosses 12. The housing base 11 is sealed to the window frame with a Neoprean seal 13. Handle 14 is secured to base 11 for pivoting about first axis 15 through a predetermined angle of approximately 180°. Handle 14 generally extends in a first radial direction as indicated in FIG. 1 from first axis 15.

A drive link 16 is secured for pivoting with handle 14. This connection of drive link 16 with handle 14 is provided through a hexagon stud 17 which snugly engages into hexagon socket 18 of handle 14. This connection is maintained through the use of a securing pin 19 which passes through pin passage 20 in stud 17 and socket 18 with a press fit. Stud 17 passes through a passage 21 provided in housing 11. Engagement of socket 20 against annular extension 22 of housing 11 is fictionally minimized through the use of nylon washer 23. Drive link 16 is best secured for pivoting with handle 14 in a generally opposite direction whereby drive link 16 generally extends in a second radial direction from first axis 15.

Connecting link 24 is hooked at its distal end 25 to a lock control member or tie bar (not shown) in conventional fashion for a window lock structure. For example, the connecting link 24 may be suitably secured to the tie bar of the locking structure shown in U.S. Pat. No. 4,991,886, the contents of which are hereby incorporated by reference, where pivoting of a handle 14 will cause the connecting link 24 to move an attached tie bar and thereby operate the window lock structure as is well known in the art.

The hooked end 25 is provided with a keyed flange 26 which depends from the distal end 25 at generally a right angle as is well known in the industry. The proximal end 27 of connecting link 25 is pivotally secured to drive link 16 via pivot pin 28.

Connecting link 24 is actually provided as a selectable pair 24 and 24′, 24′ being the mirror image of connecting link 24. Connecting link 24 is dimensioned and shaped for right hand operation of the lock control member as a right-hand lock and connecting link 24′ is dimensioned in shape for left-hand operation of the lock control member as a left-hand lock. Accordingly, upon installation, one of the connecting links 24 and 24′ will be discarded depending upon whether the window lock is right-handed or left-handed. Similar or like parts of connecting link 24′ are indicated with the same numerals but differentiated only by a prime mark. The linkage arrangement illustrated in FIG. 1 is set up for right-hand operation. In this situation, connecting link 24′ would be discarded.

The connecting links 24 and 24′ are L-shaped and the proximal ends 27 or 27′ of the selected connecting link is received in a cavity 30 provided in base 11 and pivot pin 28 pivotally connects selected connecting link 24 to drive link 16 within the cavity 30. Thus, pivot pin 28 and proximal end 27 or 27′ of the connecting link and drive link 16 are always confined and contained within the cavity 30 of base 11. The cavity 30 of base 11 is therefore dimensioned for retaining and confining pivot pin 28, the proximal end 27 or 27′ of connecting link 24 or 24′ and drive link 16 in confined and combined pivotal connection without the requirement of other mechanical securement. In this manner, no special fasteners or other securement elements are required to maintain these three elements in combined configuration which reduces the cost of manufacture and also extends the reliability of the actuator 10 as there is no reliance upon conventional fasteners which tend to fail.

Pivot pin 28 is smaller in diameter as indicated at end 31 thereby providing an annular shoulder 32 for supporting connecting link 24 at its proximal end 27 in spaced relationship from drive link 16. This prevents the two links from mechanically binding against each other as the actuator 10 is operated. Accordingly, pivot pin 28 is at right angles to and the ends thereof are slidably confined within the sidewall dimensions 33 of cavity 30. Pivot pin 28 is also provided with a non-rotatable keyed engagement 34 with drive link 16. This therefore limits all rotatable engagement between the links 16 and 24 as between the proximal end 27 and the shoulder pin portion 31 of pivot pin 28.

I claim:

1. A non-handed actuator for window locks of the type in which a lock control member is moved by said actuator to control the locking of a window sash to a window frame, said actuator comprising:
a housing base securable to the window frame;
a handle secured to said base for pivoting about a first axis through a predetermined angle, said handle generally extending in a first radial direction from said first axis;
a drive link secured for pivoting with said handle, said drive link generally extending in a second radial direction from said first axis;
a connecting link securable at a distal end thereof to the lock control member of a window lock with a keyed flange depending from said distal end at generally a right angle, said connecting link pivotally secured at a proximal end thereof to said drive link;
said connecting link provided as a selectable pair wherein one connecting link is dimensioned and shaped for right hand operation of the lock control member as a right hand lock and the other connecting link is dimensioned and shaped for left hand operation of the lock control member as a left hand lock.

2. The non-handed actuator of claim 1, wherein said right hand and left hand connecting links are generally L-shaped and said proximal end of the selected connecting link is received in a cavity provided in said base and a pivot pin pivotally connects said connecting link to said drive link, said cavity dimensioned for retaining and confining said pivot pin, said proximal end of said connecting link and said drive link in confined pivotal connection without other mechanical securement.

3. A non-handed actuator for window locks of the type in which a lock control member is moved by said actuator to control the locking of a window sash to a window frame, said actuator comprising:
a housing base securable to the window frame;
a handle secured to said base for pivoting about a first axis through a predetermined angle, said handle generally extending in a first radial direction from said first axis;
a drive link secured for pivoting with said handle, said drive link generally extending in a second radial direction from said first axis;
a connecting link securable at a distal end thereof to the lock control member of a window lock with a keyed flange depending from said distal end at generally a right angle, said connecting link pivotally secured at a proximal end thereof to said drive link;
said connecting link being generally L-shaped and said proximal end received in a cavity provided in said base and a pivot pin pivotally connecting said connecting link to said drive link, said cavity dimensioned for retaining and confining said pivot pin, said proximal end of said connecting link and said drive link in combined pivotal connection without other mechanical securement.

4. The non-handed actuator of claim 3, wherein said pivot pin is smaller in diameter at one end thereof and thereby providing an annular shoulder for supporting said connecting link in spaced relationship from said drive link.

5. The non-handed actuator of claim 4, wherein opposite ends of said pivot pin are slidably confined within the dimensions of said cavity.

6. The non-handed actuator of claim 5, wherein the other end of said pivot pin is in non-rotatable keyed engagement with said drive link.
